(19) United States
(12) Patent Application Publication
(10) Pub. No.: US 2011/0276738 A1
(43) Pub. Date: Nov. 10, 2011

(54) SENSOR NODE INCLUDING GENERAL-PURPOSE INTERFACE PORT AND PLUG AND PLAY FUNCTION, SENSOR BOARD INCLUDING GENERAL-PURPOSE INTERFACE PORT AND SENSOR DEVICE DRIVER, GENERAL-PURPOSE INTERFACE PORT, AND OPERATION METHOD OF SENSOR NODE, SENSOR BOARD, AND GENERAL-PURPOSE INTERFACE PORT

(75) Inventors: Se Han KIM, Daejeon (KR); Kyo Hoon SON, Daejeon (KR); Nae Soo KIM, Daejeon (KR); Cheol Sig PYO, Daejeon (KR); Ho Yong KANG, Daejeon (KR); Hoon JEONG, Daejeon (KR); Seong Bae EUN, Daejeon (KR)

(73) Assignee: Electronics and Telecommunications Research Institute, Daejeon (KR)

(21) Appl. No.: 13/097,868

(22) Filed: Apr. 29, 2011

(30) Foreign Application Priority Data
Apr. 29, 2010 (KR) 10-2010-0039933
Oct. 26, 2010 (KR) 10-2010-0104922

(51) Int. Cl. G06F 13/00

(52) U.S. Cl. 710/300

(57) ABSTRACT

Provided is a general-purpose interface port that may interface with a sensor board including multiple types of sensor device drivers and download a sensor device driver from the sensor board, and a sensor node that may recognize a type of sensor included in the sensor board using the downloaded sensor device driver, the sensor node including a micro control unit that may process sensing data received from the sensor board, thereby providing a plug and play function between a micro control unit of a sensor node and a sensing unit including a sensor board in a Ubiquitous Sensor Network (USN) or a Wireless Sensor Network (WSN).

### CROSS-REFERENCE TO RELATED APPLICATIONS

This application claims the benefit of Korean Patent Application No. 10-2010-0039933, filed on Apr. 29, 2010, and Korean Patent Application No. 10-2010-0104922, filed on Oct. 26, 2010, in the Korean Intellectual Property Office, the disclosures of which are incorporated herein by reference.

### BACKGROUND

1. Field of the Invention

The present invention relates to a method of providing an efficient interface between a micro control unit of a sensor node and a sensing unit.

2. Description of the Related Art

Generally, a Ubiquitous Sensor Network (USN) and a Wireless Sensor Network (WSN) correspond to a network including a plurality of sensor nodes that may sense recognition information of an object or peripheral environment information. The USN and the WSN provides a function of real time processing or real time management of the information sensed by each of the plurality of sensors.

The USN system may provide a computing function and a communication function to various objects, and may provide an environment enabling communication anytime, anywhere, and regardless of a network, a device, and a type of service.

FIG. 1 is a block diagram illustrating a configuration of a sensor node according to a conventional art.

Referring to FIG. 1, a sensor node 100 may include a sensing unit 110, a micro control unit (MCU) 120, a communicator 130, and a power supply unit 140.

The MCU 120 may process sensing data of a sensor included in a sensor board, and manage a peripheral unit, a timer, and a power supply for an external interface. The MCU 120 may be configured for multiple performances and a flexible configuration depending on a purpose of the sensor node 100, and may include a sensor device driver, an operation system or firmware, an application, and the like.

The communicator 130 may vary in a communication scheme, a communication distance, an amount of data, and the like, and may be configured with a technology for minimum electricity consumption and efficient use of a limited wireless resource.

The sensing unit 100 may generate a physical analog signal of a sensor included in the sensor board such as a temperature, a humidity, a light, a magnitude, a sound, an acceleration, and the like, may generate multiple sensing data from an analog signal to a digital signal, and may transmit the generated sensing data to the MCU 120. The sensing unit 110 may be configured in multiple forms according to a peripheral digital interface.

The power supply unit 140 may include a primary cell or a secondary cell for a stable power supply, and may use various self-charging schemes depending on an application.

In using a sensor having standards and interfaces as various as a range of the USN, there is a desire to simplify and reduce complexity of a sensor board including a sensor for mass production, and for easy and convenient development.

Sensors currently used in the USN have an interface such as a Serial Peripheral Interface (SPI), an Inter-Integrated Circuit (I2C), an analog-to-digital converter (ADC), an interrupt, a frequency, a General Purpose Input/Output (GPIO), and the like. The MCU 120 to process sensing data, may include a sensor or a sensor device driver to control a sensor board. When the sensor board is changed, all software included in the MCU may be changed and accordingly, mass production and advances in development are difficult to be achieved.

### SUMMARY

An aspect of the present invention provides a sensor node including a general-purpose interface port and a plug and play function that may simplify and reduce complexity of an interface between a sensing unit and a micro control unit (MCU) by unifying the interface between the sensing unit including multiple types of sensors, and the MCU. Simultaneously, the MCU of the sensor node may automatically recognize the sensing unit using the general-purpose interface port and control the sensing unit.

Another aspect of the present invention also provides a sensor board including a general-purpose interface port and a sensor device driver that may automatically recognize a type of a sensor included in a sensor node by pre-storing, on the sensor board, the sensor device driver associated with multiple types of sensors, and by downloading, to the sensor node, the sensor device driver stored in the sensor board when the sensor board and the sensor node are connected.

Another aspect of the present invention also provides a general-purpose interface port to easily interface with multiple types of sensors by reduce complexity of an interface between a sensing unit and a MCU.

According to an aspect of the present invention, there is provided a sensor node including a general-purpose interface port and a plug and play function, including: the general-purpose interface port to interface with a sensor board, and to download a sensor device driver from the interfaced sensor board; and a MCU to control the sensor board, and to process sensing data generated by a sensor included in the sensor board, the micro control unit using the downloaded sensor device driver to control the sensor board and using the downloaded sensor to process sensing data.

The general-purpose interface port may download a sensor device driver associated with at least one of a Serial Peripheral Interface (SPI), an Inter-Integrated Circuit (I2C), an analog-to-digital converter (ADC), an interrupt, and a frequency.

The sensor node may further include a power supply unit to supply a power to the sensor board interfaced with the general-purpose interface port.

The sensor node may further include a sensing unit to generate multiple types of sensing data based on a sensor included in the sensor board, the sensing unit including the sensor board.

According to an aspect of the present invention, there is also provided a sensor board including a general-purpose interface port and a sensor device driver, including: an authentication module to provide the sensor device drivers to a sensor node connected with the general-purpose interface port, the authentication module including sensor device drivers associated with processing of multiple types of sensing data, and a sensor to generate multiple types of sensing data, and to provide the generated sensing data to the sensor node using the general-purpose interface port.

The sensor may generate sensing data in a form of at least one of an SPI, an I2C, an ADC, an interrupt, and a frequency.

According to an aspect of the present invention, there is also provided a general-purpose interface port, including: a sensor output connection port to interface between a sensor node and a sensor board, the sensor output connection port including n pins, n being a natural number, and a download port to download, to the sensor node, a sensor device driver stored in the sensor board, the download port including m pins, and m being a natural number.

The general-purpose interface port may further include a power supply port to receive a power supply from the sensor node, the power supply port including k pins, and k being a natural number.

The general-purpose interface port may further include an extension port to physically connect the sensor node and the sensor board, including v pins, and v being a natural number.

According to an aspect of the present invention, there is also provided a method of operating a sensor node, including: downloading a sensor device driver from a sensor board interfaced with a general-purpose interface port, controlling the sensor board using the downloaded sensor device driver, processing sensing data generated by a sensor included in the sensor board.

According to an aspect of the present invention, there is also provided a method of operating a sensor board, including: storing a sensor device drivers associated with processing of multiple types of sensing data, providing the sensor device drivers to a sensor node connected with a general-purpose interface port, generating multiple types of the sensing data, and providing the generated sensing data to the sensor node using the general-purpose interface port.

According to an aspect of the present invention, there is also provided a method of operating a general-purpose interface port, including: interfacing between a sensor node and a sensor board using a sensor output connection port including n pins, n being a natural number, and downloading, to the sensor node, a sensor device driver stored in the sensor board using a download port including m pins, m being a natural number.

### EFFECT OF THE INVENTION

According to an aspect of the present invention, it is possible to reduce a shortcoming of consuming an additional cost and additional manufacturing time due to a change of hardware of a sensor node based on a type of a sensor attached to a sensor board by unifying and reduce complexity of an interface between a micro control unit (MCU) of the sensor node and a sensing unit of the sensor node.

According to an aspect of the present invention, it is also possible to reduce a shortcoming of revising software of a sensor node due to a change of a type of a sensor by downloading a sensor device driver from a sensor board to the sensor node immediately when the sensor node and the sensor board are connected using a general-purpose interface port, and by recognizing the type of the sensor in the sensor node.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of a sensor node according to a conventional art;

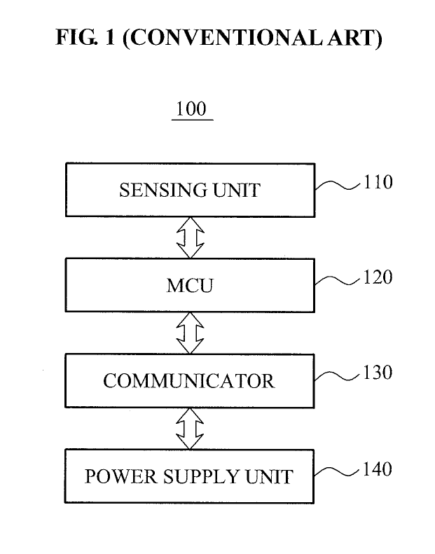

FIG. 2 is a block diagram illustrating a configuration of a sensor node including a general-purpose interface port and a plug and play function according to an embodiment of the present invention;

FIG. 3 is a block diagram illustrating a configuration of a sensor node including a general-purpose interface port and a plug and play function according to another embodiment of the present invention;

FIG. 4 is a block diagram illustrating a configuration of a sensor board including a general-purpose interface port and a sensor device driver associated with a Serial Peripheral Interface (SPI) according to an embodiment of the present invention;

FIG. 5 is a block diagram illustrating a configuration of a sensor board including a general-purpose interface port and a sensor device driver associated with an Inter-Integrated Circuit (I2C) according to an embodiment of the present invention;

FIG. 6 is a block diagram illustrating a configuration of a sensor board including a general-purpose interface port and a sensor device driver associated with an Analog-to-Digital Convertor (ADC) according to an embodiment of the present invention;

FIG. 7 is a block diagram illustrating a configuration of a sensor board including a general-purpose interface port and a sensor device driver associated with an interrupt according to an embodiment of the present invention;

FIG. 8 is a block diagram illustrating a configuration of a sensor board including a general-purpose interface port and a sensor device driver associated with a Frequency according to an embodiment of the present invention;

FIG. 9 is a block diagram illustrating a configuration of a general-purpose interface port according to an embodiment of the present invention;

FIG. 10 is a flowchart illustrating a sequence of a method of operating a sensor node according to an embodiment of the present invention;

FIG. 11 is a flowchart illustrating a sequence of a method of operating a sensor board according to an embodiment of the present invention; and

FIG. 12 is a flowchart illustrating a sequence of a method of operating a general-purpose interface port according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

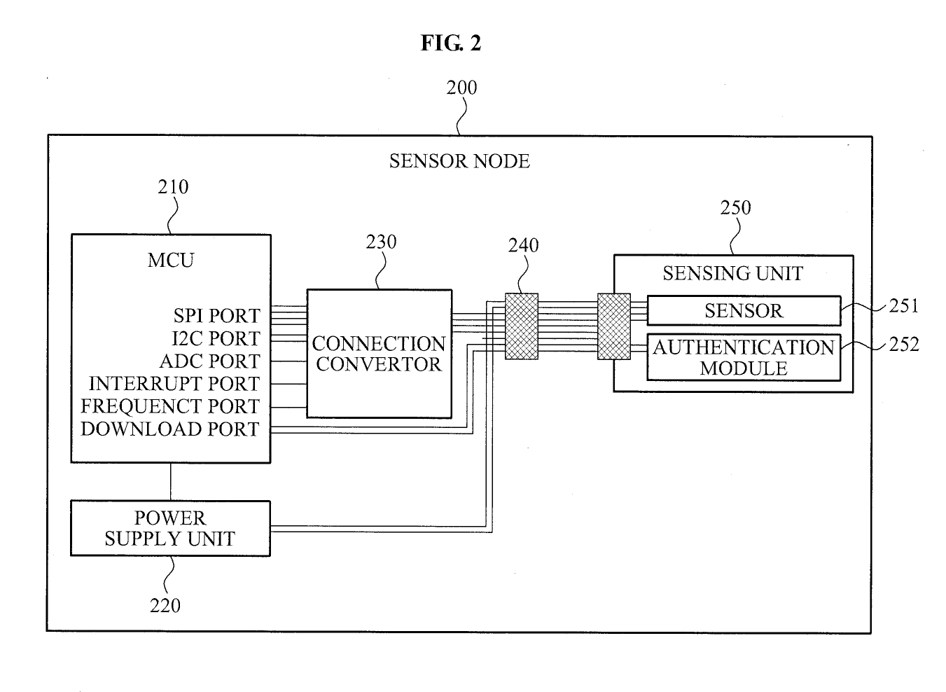

FIG. 2 is a block diagram illustrating a configuration of a sensor node including a general-purpose interface port and a plug and play function according to an embodiment of the present invention.

Referring to FIG. 2, a sensor node 200 including a general-purpose interface port and a plug and play function, hereinafter referred to as a ‘sensor node’, may include a micro control unit (MCU) 210, a power supply unit 220, a connection converter 230, a general-purpose interface port 240, and a sensing unit 250. Here, the sensing unit 250 may include a sensor board including a sensor 251 and an authentication module 252.

The sensor 251 to collect peripheral environment information may have a different output format and a required number of connection pins according to a role and a type of the sensor. However, there are five types of an interface for transmitting an output of the sensors 251 currently being manufactured. The types of the interface are a Serial Peripheral Interface (SPI) scheme, an Inter-Integrated Circuit (I2C) scheme, an analog-to-digital converter (ADC) scheme, an Interrupt scheme, and a Frequency scheme.

The general-purpose interface port 240 between the sensor node 220 and the sensor board may include nine pins in total. The general-purpose interface port 240 may include a Voltage at the Common Collector (VCC) pin that may receive a power supply that the sensor board, that is, the sensing unit requires, and a ground (GND) pin, hereinafter referred to as a ‘power supply port’, a Serial Clock (SCLK) pin and a DATA pin for downloading, to the sensor node 200, a sensor device driver that the sensor board has for a plug and play function, hereinafter referred to as a ‘download port’, four sensor interface pins for transmitting sensing data generated in the sensor 251, hereinafter referred to as a ‘sensor output connection port’, and a single extension interface pin for an additional extension, hereinafter referred to as an ‘extension port’. Here, at least one pin among the four sensor interface pins may be used based on a number of sensor output types that may be actually used. Two power supply pins of the VCC pin and the GND pin, and two sensor device driver download pins of the SCLK pin and the DATA pin are commonly used in a general-purpose interface port of all sensor boards.

When the sensing unit 250 is connected with the MCU 210 using the general-purpose interface port 240, the MCU 210 may download a sensor device driver from the authentication module 252. The sensor device driver may used for processing of sensing data differently generated based on a type of the sensor 251 included in the sensing unit 250. The sensor device driver may be associated with at least one of the SPI, the I2C, the ADC, the interrupt, and the frequency based on the type of the sensor 251.

The MCU 210 may automatically determine the type of the sensor 251 included in the sensing unit 250, and an output format of the sensing data using the downloaded sensor device driver. Also, the MCU 210 may control the connection convertor 230 and connect the connection convertor 230 with the general-purpose interface port 240.

According to the configuration, the MCU may recognize the sensing unit 250 and obtain information with respect to the type of the sensor 251 even though the MCU 210 is connected to the sensing unit 250 including a different type of the sensor 251. The power supply unit 220 may supply a power to the sensing unit 250 connected to the general-purpose interface port 240. At least two sensing units may also be connected to the general-purpose interface port 240 based on an environment of an application field.

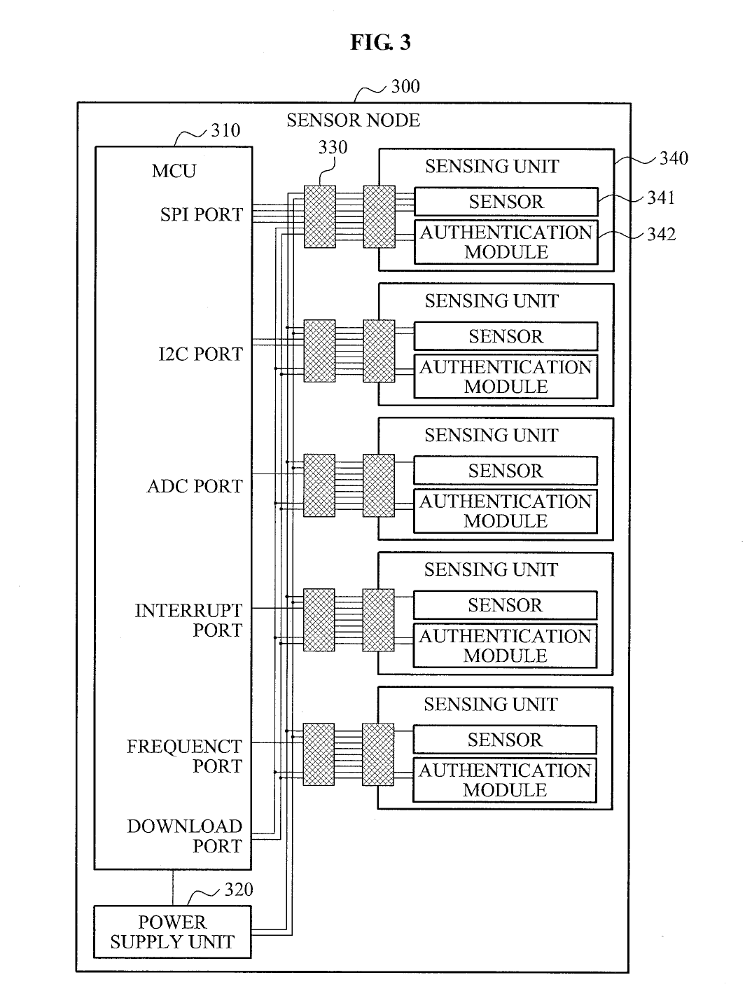

FIG. 3 is a block diagram illustrating a configuration of a sensor node including a general-purpose interface port and a plug and play function according to another embodiment of the present invention.

Referring to FIG. 3, a sensor node 300 may include a micro control unit (MCU) 310, a power supply unit 320, a general-purpose interface port 330, a sensing unit 340, and a plurality of sensing units. The single sensing unit 340 may include a sensor board including a sensor 341 and an authentication module 342.

Each of the plurality of sensing units may include a different type of sensor. The MCU 310 may process sensing data generated by the sensor 341 included in the MCU 340 by downloading, from each of the sensing units 340, a sensor device driver for processing sensing data generated in a different type of the sensors 341, and by controlling the sensing unit 340 using the downloaded sensor device driver.

Here, the sensor node 300 may directly connect the MCU 310 and the sensing unit 340 using the general-purpose interface port 330 without a connection converter, and accordingly may have an advantage of a simple configuration and an easy control.

Remaining elements are similar to corresponding elements of FIG. 2 and accordingly, detailed description thereof will be omitted herein.

As described above, the sensing unit 340 and the sensor board may be construed as identical. According to an aspect of the present invention, a sensor board including a general-purpose interface port and a sensor device driver may include sensor device drivers associated with processing of multiple types of sensing data, and also include an authentication module that may provide the sensor device drivers, and a sensor that may generate the multiple types of the sensing data, and provide the generated sensing data to the sensor node 300 using the general-purpose interface port. The sensor may generate sensing data in a form of at least one of an SPI, an I2C, an ADC, an interrupt, and a frequency.

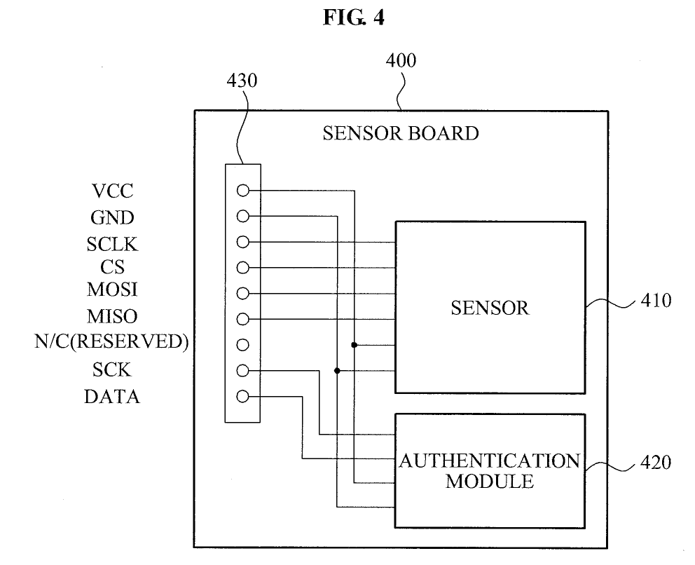

Hereinafter, a sensor board according to a type of a sensor will be described using FIG. 4 through FIG. 8 with reference to Table 1.

TABLE 1

| Interface Type | Pin Name | Sensor Output |
|---|---|---|
| SPI | Sensor Interface 1 | SCLK |
| | Sensor Interface 2 | CS |
| | Sensor Interface 3 | MOSI |
| | Sensor Interface 4 | MISO |
| I2C | Sensor Interface 1 | Sensor SCK |
| | Sensor Interface 2 | Sensor DATA |
| | Sensor Interface 3 | N/C |
| | Sensor Interface 4 | N/C |
| ADC | Sensor Interface 1 | ADC |
| | Sensor Interface 2 | N/C |
| | Sensor Interface 3 | N/C |
| | Sensor Interface 4 | N/C |
| Interrupt | Sensor Interface 1 | Interrupt |
| | Sensor Interface 2 | N/C |
| | Sensor Interface 3 | N/C |
| | Sensor Interface 4 | N/C |
| Frequency | Sensor Interface 1 | Frequency |
| | Sensor Interface 2 | N/C |
| | Sensor Interface 3 | N/C |
| | Sensor Interface 4 | N/C |

FIG. 4 is a block diagram illustrating a configuration of a sensor board including a general-purpose interface port and a sensor device driver associated with an SPI according to an embodiment of the present invention.

Referring to FIG. 4, a sensor board 400 including a general-purpose interface port and a sensor device driver associated with an SPI, hereinafter referred to as a ‘sensor board’, may include a sensor 410, an authentication module 420, and a general-purpose interface port 430.

The authentication module 420 may include sensor device drivers associated with the SPI, and generate the sensor device drivers associated with the SPI to the sensor node 300 connected with the general-purpose interface port 430.

The sensor 410 may generate an SPI-associated type of sensing data, and provide the generated sensing data to the sensor node 300 using the general-purpose interface port 430.

Referring to Table 1, when sensing data corresponding to an output of the sensor board 400 is transmitted using the SPI scheme, four pins may be used as the general-purpose interface port 430. For example, the general-purpose interface port 430 may include ports that are respectively associated with an SCLK, a CS, an MOSI, and an MISO (sensor interfaces 1 through 4), and sensor output connection ports 1 through 4.

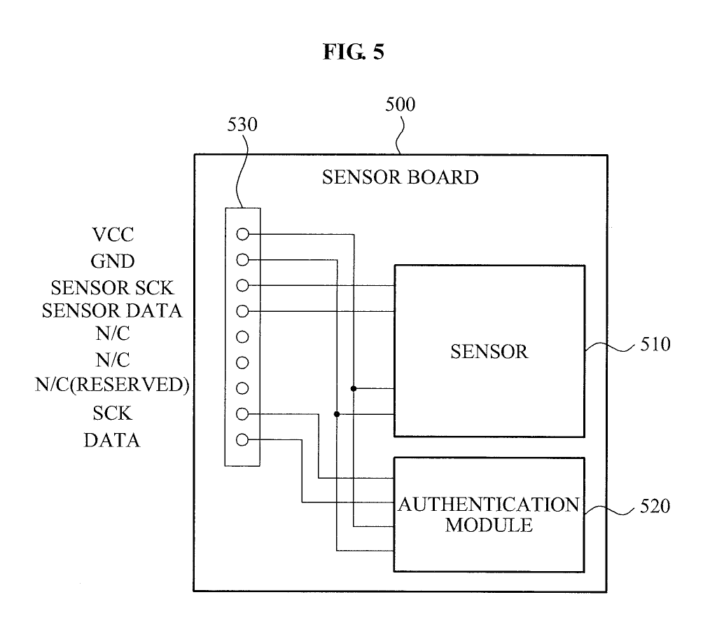

FIG. 5 is a block diagram illustrating a configuration of a sensor board including a general-purpose interface port and a sensor device driver associated with an I2C according to an embodiment of the present invention.

Referring to FIG. 5, a sensor board 500 associated with an I2C may include a sensor 510, an authentication module 520, and a general-purpose interface port 530.

The authentication module 520 may include sensor device drivers associated with the I2C, and generate the sensor device drivers associated with the I2C to the sensor node 300 connected with the general-purpose interface port 530.

The sensor 510 may generate an I2C-associated type of sensing data, and provide the generated sensing data to the sensor node 300 using the general-purpose interface port 530.

Referring to Table 1, when sensing data corresponding to an output of the sensor board 500 is transmitted using the I2C scheme, two pins may be used as the general-purpose interface port 530. The general-purpose interface port 530 may connect outputs of an SCLK and a Data (sensor interfaces 1 and 2) respectively to a sensor output connection port 1 and a sensor output connection port 2, and may process the remaining ports as Not Connected (N/C). Here, the SCLK port and the DATA port may use identical names with the two pins for downloading the sensor device driver, however, the SCLK port and the DATA port may independently operate as a physically different pin.

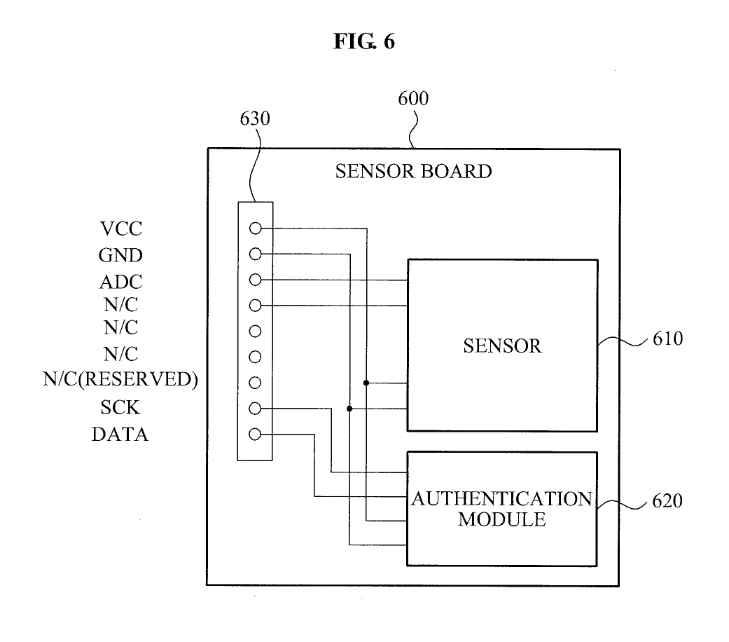

FIG. 6 is a block diagram illustrating a configuration of a sensor board including a general-purpose interface port and a sensor device driver associated with an ADC according to an embodiment of the present invention.

Referring to FIG. 6, a sensor board 600 associated with an ADC may include a sensor 610, an authentication module 620, and a general-purpose interface port 630.

The authentication module 620 may include sensor device drivers associated with the ADC, and generate the sensor device drivers associated with the ADC to the sensor node 300 connected with the general-purpose interface port 630.

The sensor 610 may generate an I2C-associated type of sensing data, and provide the generated sensing data to the sensor node 300 using the general-purpose interface port 630.

Referring to Table 1, when sensing data corresponding to an output of the sensor board 600 is transmitted using the ADC scheme, a single pin may be used as the general-purpose interface port 630. The general-purpose interface port 630 may be connected with a sensor output connection port 1 (a sensor interface 1), and the remaining ports may be processed as N/C.

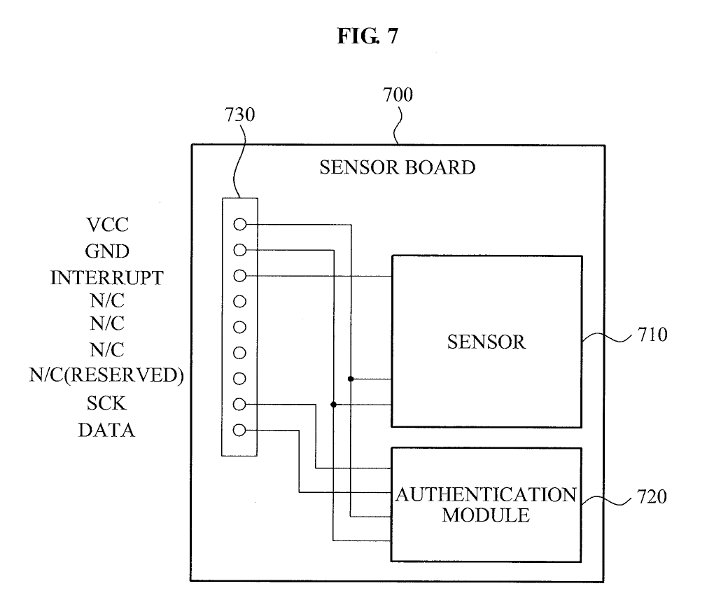

FIG. 7 is a block diagram illustrating a configuration of a sensor board including a general-purpose interface port and a sensor device driver associated with an interrupt according to an embodiment of the present invention.

Referring to FIG. 7, a sensor board 700 associated with an interrupt may include a sensor 710, an authentication module 720, and a general-purpose interface port 730.

The authentication module 720 may include sensor device drivers associated with the interrupt, and generate the sensor device drivers associated with the interrupt to the sensor node 300 connected with the general-purpose interface port 730.

The sensor 710 may generate an interrupt-associated type of sensing data, and provide the generated sensing data to the sensor node 300 using the general-purpose interface port 730.

When sensing data corresponding to an output of the sensor board 700 is transmitted using the Interrupt scheme, a single pin may be used as the general-purpose interface port 730 with reference to Table 1. The general-purpose interface port 730 may be connected with a sensor output connection port 1 (a sensor interface 1), and the remaining ports may be processed as N/C.

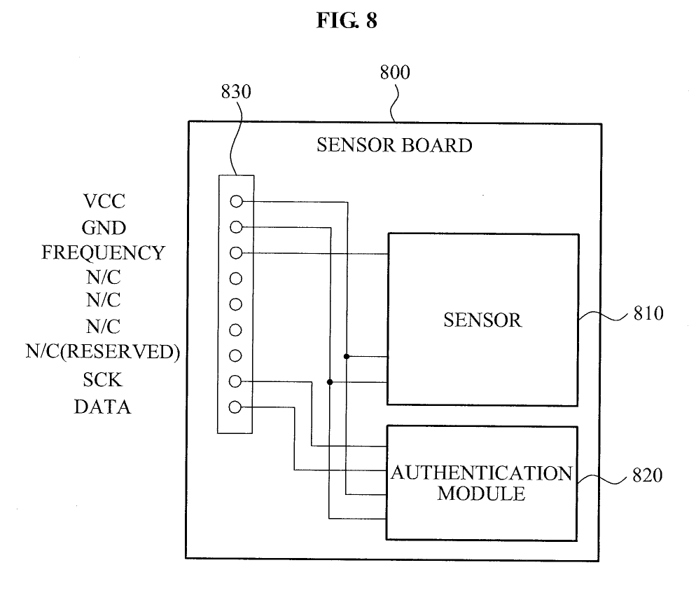

FIG. 8 is a block diagram illustrating a configuration of a sensor board including a general-purpose interface port and a sensor device driver associated with a frequency according to an embodiment of the present invention.

Referring to FIG. 8, a sensor board 800 associated with a frequency may include a sensor 810, an authentication module 820, and a general-purpose interface port 830.

The authentication module 820 may include sensor device drivers associated with the frequency, and generate the sensor device drivers associated with the frequency to the sensor node 300 connected with the general-purpose interface port 830.

The sensor 810 may generate a frequency-associated type of sensing data, and provide the generated sensing data to the sensor node 300 using the general-purpose interface port 830.

Referring to Table 1, when sensing data corresponding to an output of the sensor board 800 is transmitted using the frequency scheme, a single pin may be used as the general-purpose interface port 830. The general-purpose interface port 830 may be connected with a sensor output connection port 1 (a sensor interface 1), and the remaining ports may be processed as N/C.

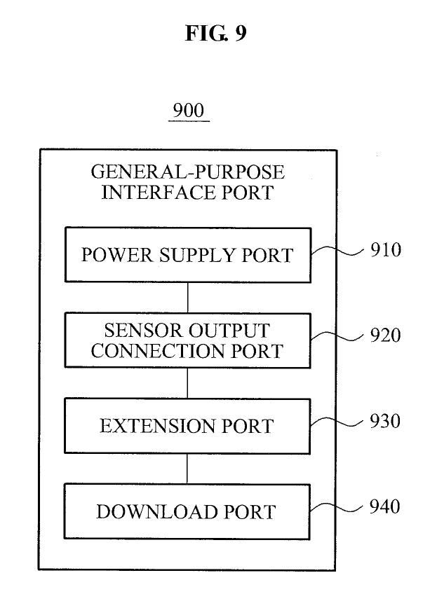

FIG. 9 is a block diagram illustrating a configuration of a general-purpose interface port according to an embodiment of the present invention.

Referring to FIG. 9, a general-purpose interface port 900 may include a power supply port 910, a sensor output connection port 920, an extension port 930, and a download port 940.

The power supply port 910 may include k pins, k being a natural number, and receive a power supply from the sensor node 300. For example, k may correspond to 2 and the power supply port 910 may include a VCC pin and a GND pin.

The sensor output connection port 920 may include n pins, n being a natural number, and may interface between the sensor node 300 and any one of the sensor board 400, the sensor board 500, the sensor board 600, the sensor board 700, and the sensor board 800, hereinafter collectively referred to as the ‘sensor board 800’. For example, n may be correspond to from 1 to 4 based on a number of sensor outputs that are actually used, and the sensor output connection port 920 may transmit sensing data from the sensor board 800 to the sensor node 300.

The extension port 930 may include v pins, v being a natural number, and may correspond to a port to physically connect the sensor node 300 and the sensor board 800. For example, v may correspond to 1, and the extension port 930 may transmit sensing data from the sensor board 800 to the sensor node 300 similarly with the sensor output connection port 920.

The download port 940 may correspond to a port that may download, to the sensor node 300, a sensor device driver that the sensor board may include for a plug and play function. The download port 940 may include m pins, m being a natural number, and may download, to the sensor node 300, the sensor device driver stored in the sensor board 800. For example, m may correspond to 2, and the download port 940 may include an SCLK pin and a DATA pin.

The general-purpose interface port 900 may be commonly used in the sensor node 300 and the sensor board 800.

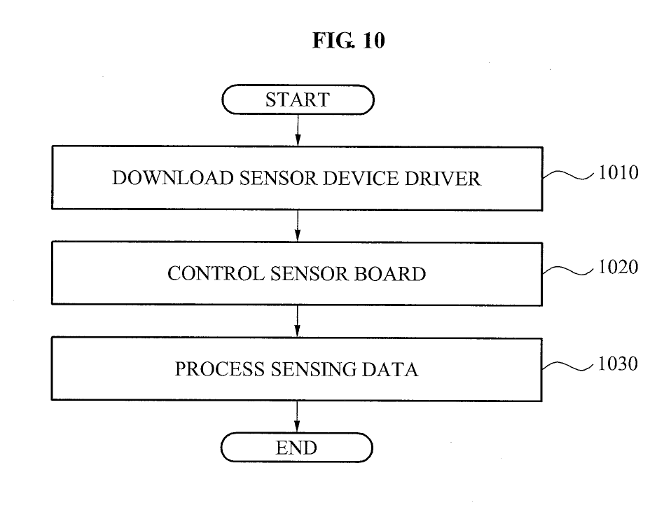

FIG. 10 is a flowchart illustrating a sequence of a method of operating a sensor node according to an embodiment of the present invention.

Referring to FIG. 10, the sensor node 300 may download a sensor device driver from the sensor board 800 interfaced with the general-purpose interface port 330 in operation 1010. The sensor device driver may be used for processing sensing data differently generated based on a type of the sensor 341 included in the sensing unit 340. For example, the sensor device driver may be associated with at least one of an SPI, an I2C, an ADC, an interrupt, and a frequency based on the type of the sensor 341.

In operation 1020, the sensor node 300 may control the sensor board 800 using the downloaded sensor device driver. The sensor board 800 may refer to the sensing unit 340 included in the sensor node 300.

In operation 1030, the sensor node 300 may process the sensing data generated by the sensor 810 included in the sensor board 800. For example, the sensor node 300 may process sensing data generated in the sensor 410 of the SPI-associated sensor board 400 using an SPI scheme, sensing data generated in the sensor 510 of the I2C-associated sensor board 500 using an I2C scheme, sensing data generated in the sensor 610 of the ADC-associated to sensor board 600 using an ADC scheme, sensing data generated in the sensor 710 of the interrupt-associated sensor board 700 using an Interrupt scheme, and sensing data generated in the sensor 810 of the Frequency-associated sensor board 800 using a Frequency scheme.

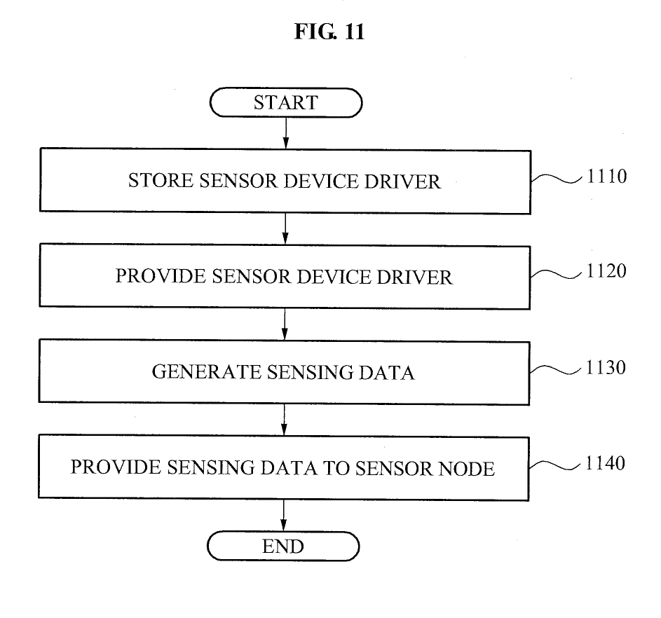

FIG. 11 is a flowchart illustrating a sequence of a method of operating a sensor board according to an embodiment of the present invention.

Referring to FIG. 11, the sensor board 800 may store sensor device drivers associated with processing of multiple types of sensing data in operation 1110. The sensor board 800 may correspond to any one of the sensor board of FIG. 4, the sensor board of FIG. 5, the sensor board of FIG. 6, the sensor board of FIG. 7, and the sensor board of FIG. 8 based on a type of the sensor.

In operation 1120, the sensor board 800 may provide the sensor device drivers to the sensor node 300 connected to the general-purpose interface port 830.

In operation 1130, the sensor board 800 may generate the multiple types of the sensing data. For example, the sensor board 800 may generate sensing data using an SPI scheme, an I2C scheme, an ADC scheme, an Interrupt scheme, and using a Frequency scheme.

In operation 1140, the sensor board 800 may provide the generated sensing data to the sensor node 300 using the general-purpose interface port 830.

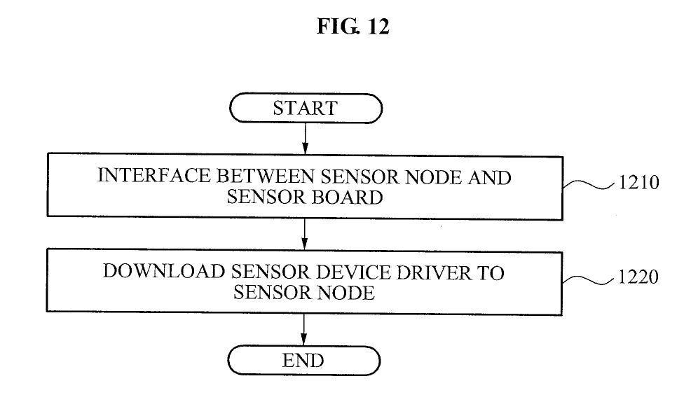

FIG. 12 is a flowchart illustrating a sequence of a method of operating a general-purpose interface port according to an embodiment of the present invention.

Referring to FIG. 12, the general-purpose interface port 900 may interface between the sensor node 300 and the sensor board 800 using a sensor output connection port including n pins, n being a natural number in operation 1210.

In operation 1220, the general-purpose interface port 900 may download, to the sensor node 300, a sensor device driver stored in the sensor board 800 using a download port including m pins, m being a natural number.

Referring to Table 1, when sensing data is transmitted using the SPI scheme, the general-purpose interface port 900 may use four pins, and an SCLK pin, a CS pin, an MOSI pin, and an MISO pin may be sequentially connected to a sensor interface pin 1, a sensor interface pin 2, a sensor interface pin 3, and a sensor interface pin 4, that is, to the sensor output connection port.

When sensing data is transmitted using an I2C scheme, the general-purpose interface port 900 may use two pins, and an SCLK output and an DATA output may be respectively connected to the sensor interface pin 1 and the sensor interface pin 2, and the remaining pins may be processed as N/C.

When sensing data is transmitted using any one of an ADC scheme, an Interrupt scheme, and a Frequency scheme, the general-purpose interface port 900 may use a single sensor interface pin. An output of each of the sensors may be connected to a sensor interface pin 1, and the remaining pins may be processed as N/C.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A sensor node comprising a general-purpose interface port and a plug and play function, the sensor node comprising:
the general-purpose interface port to interface with a sensor board, and to download a sensor device driver from the interfaced sensor board; and
a micro control unit, to control the sensor board, and to process sensing data generated by a sensor included in the sensor board, the micro control unit using the downloaded sensor device driver to control the sensor board and using the downloaded sensor to process sensing data.

2. The sensor node of claim 1, wherein the general-purpose interface port downloads a sensor device driver associated with at least one of a Serial Peripheral Interface (SPI), an Inter-Integrated Circuit (I2C), an analog-to-digital converter (ADC), an interrupt, and a frequency.

3. The sensor node of claim 1, further comprising:
a power supply unit to supply a power to the sensor board interfaced with the general-purpose interface port.

4. The sensor node of claim 1, further comprising:
a sensing unit to generate multiple types of sensing data based on a sensor included in the sensor board, the sensing unit comprising the sensor board.

5. A sensor board comprising a general-purpose interface port and a sensor device driver, the sensor board comprising:
an authentication module to provide the sensor device drivers to a sensor node connected with the general-purpose interface port, the authentication module comprising sensor device drivers associated with processing of multiple types of sensing data; and
a sensor to generate multiple types of sensing data, and to provide the generated sensing data to the sensor node using the general-purpose interface port.

6. The sensor board of claim 5, the sensor generates sensing data in a form of at least one of an SPI, an I2C, an ADC, an interrupt, and a frequency.

7. A general-purpose interface port, comprising:
a sensor output connection port to interface between a sensor node and a sensor board, the sensor output connection port comprising n pins, and n being a natural number; and
a download port to download, to the sensor node, a sensor device driver stored in the sensor board, the download port comprising m pins, and m being a natural number.

8. The general-purpose interface port of claim 7, further comprising:
a power supply port to receive a power supply from the sensor node, the power supply port comprising k pins, and k being a natural number.

9. The general-purpose interface port of claim 7, further comprising:
an extension port to physically connect the sensor node and the sensor board, the extension port comprising v pins, and v being a natural number.

10. A method of operating a sensor node, comprising:
downloading a sensor device driver from a sensor board interfaced with a general-purpose interface port;
controlling the sensor board using the downloaded sensor device driver;
processing sensing data generated by a sensor included in the sensor board.

11. The sensor node operation method of claim 10, wherein the downloading of the sensor device driver comprises downloading a sensor device driver associated with at least one of a Serial Peripheral Interface (SPI), an Inter-Integrated Circuit (I2C), an analog-to-digital converter (ADC), an interrupt, and a frequency.

12. The method of claim 10, further comprising:
supplying a power to the sensor board interacted with the general-purpose interface port.

13. The method of claim 10, further comprising:
generating multiple types of sensing data based on a sensor included in the sensor board.

14. A method of operating a sensor board, comprising:
storing a sensor device drivers associated with processing of multiple types of sensing data;
providing the sensor device drivers to a sensor node interacted with a general-purpose interface port;
generating multiple types of the sensing data; and
providing the generated sensing data to the sensor node using the general-purpose interface port.

15. The method of claim 14, wherein the generating of multiple types of the sensing data comprises generating sensing data in a form of at least one of a Serial Peripheral Interface (SPI), an Inter-Integrated Circuit (I2C), an analog-to-digital converter (ADC), an interrupt, and a frequency.

16. A method of operating a general-purpose interface port, comprising:
interfacing between a sensor node and a sensor board using a sensor output connection port comprising n pins, n being a natural number; and
downloading, to the sensor node, a sensor device driver stored in the sensor board using a download port comprising m pins, m being a natural number.

17. The method of claim 16, further comprising:
receiving a power supply from the sensor node using a power supply port comprising k pins, k being a natural number.

18. The method of claim 16, further comprising:
providing a physical connection of the sensor node and the sensor board using an extension port comprising v pins, v being a natural number.
